(19) United States
(12) Patent Application Publication
(10) Pub. No.: US 2016/0285787 A1
(43) Pub. Date: Sep. 29, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Yuichi KAWATA, Kanagawa (JP); Hisaji HIRAMATSU, Kanagawa (JP); Kei HATANO, Kanagawa (JP); Tadamasa SAKAMAKI, Kanagawa (JP); Takanori FUKUOKA, Kanagawa (JP)

(73) Assignee: FUJI XEROX CO., LTD., Tokyo (JP)

(21) Appl. No.: 14/847,740

(22) Filed: Sep. 8, 2015

(30) Foreign Application Priority Data
Mar. 24, 2015 (JP) 2015-061750

(51) Int. Cl. H04L 12/861

(52) U.S. Cl. CPC H04L 49/9089

(57) ABSTRACT

An information processing apparatus includes a request obtaining unit, a request memory, a timeout value obtaining unit, a determining unit, and a discarding unit. The request obtaining unit sequentially obtains requests from plural external apparatuses. The request memory stores the requests. The timeout value obtaining unit obtains timeout values, each of the timeout values indicating a time until transmission of a request from one of the plural external apparatuses is stopped. The determining unit determines, in a case where a request is obtained, whether or not the request memory has enough space for additionally storing the request. The discarding unit discards, in a case where the determining unit determines that the request memory does not have the enough space, a request that is selected in accordance with the timeout values obtained by the timeout value obtaining unit.

### CROSS-REFERENCE TO RELATED APPLICATIONS

This application is based on and claims priority under 35 USC 119 from Japanese Patent Application No. 2015-061750 filed Mar. 24, 2015.

### BACKGROUND

(i) Technical Field

The present invention relates to an information processing apparatus, an information processing method, and a non-transitory computer readable medium.

(ii) Related Art

In recent years, there has been suggested an apparatus that receives and stores plural packets and then performs processing in accordance with the packets and that has a reduced capacity of a buffer for storing packets.

### SUMMARY

According to an aspect of the invention, there is provided an information processing apparatus including a request obtaining unit, a request memory, a timeout value obtaining unit, a determining unit, and a discarding unit. The request obtaining unit sequentially obtains requests from plural external apparatuses. The request memory stores the requests. The timeout value obtaining unit obtains timeout values, each of the timeout values indicating a time until transmission of a request from one of the plural external apparatuses is stopped. The determining unit determines, in a case where a request is obtained, whether or not the request memory has enough space for additionally storing the request. The discarding unit discards, in a case where the determining unit determines that the request memory does not have the enough space, a request that is selected in accordance with the timeout values obtained by the timeout value obtaining unit.

### BRIEF DESCRIPTION OF THE DRAWINGS

An exemplary embodiment of the present invention will be described in detail based on the following figures, wherein:

FIG. 1 is a diagram for describing an environment in which an information processing apparatus is used;

FIG. 2 is a diagram for describing the configuration of a communication unit;

FIG. 3 is a diagram for describing an example of information stored in a request memory;

FIG. 4 is a diagram for describing an example of a timeout value table;

FIG. 5 is a diagram illustrating an example of a flow of processing that is performed when the information processing apparatus is activated; and

FIG. 6 is a diagram illustrating an example of a flow of processing that is performed when the information processing apparatus shifts between a power saving mode and a normal mode.

### DETAILED DESCRIPTION

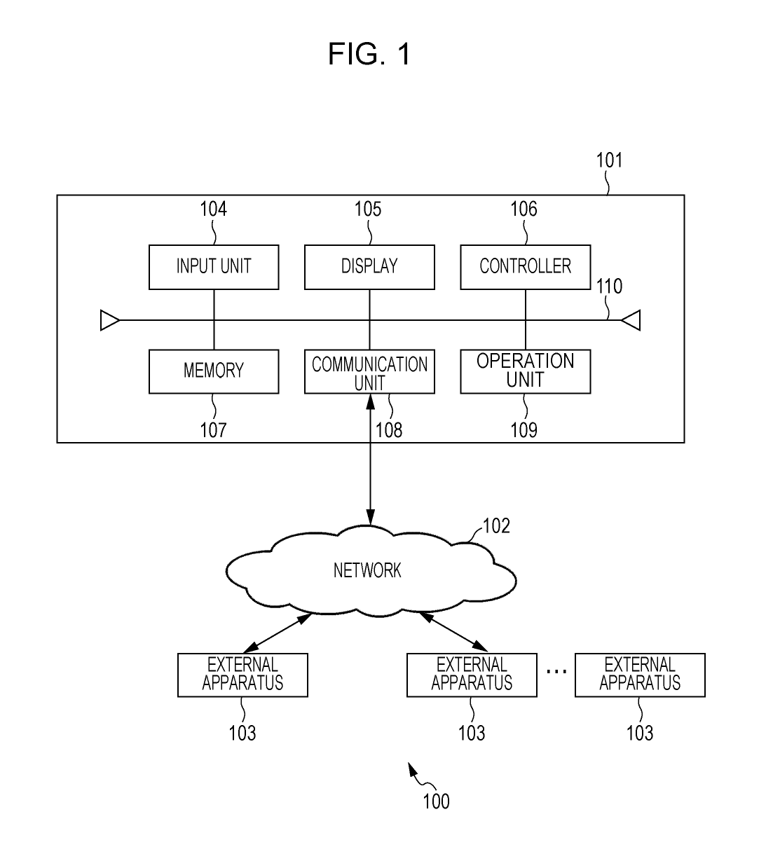

Hereinafter, an exemplary embodiment of the present invention will be described with reference to the drawings. In the drawings, the same or equivalent elements are denoted by the same reference numerals, and a duplicate description is omitted. FIG. 1 is a diagram for describing an environment in which an information processing apparatus 101 according to the exemplary embodiment is used. As illustrated in FIG. 1, an information processing system 100 includes the information processing apparatus 101, a network 102, and external apparatuses 103. The information processing apparatus 101 communicates with the external apparatuses 103 via the network 102.

The information processing apparatus 101 is, for example, an apparatus that performs printing, scanning, and so forth, and includes an input unit 104, a display 105, a controller 106, a memory 107, a communication unit 108, an operation unit 109, and an internal bus 110. The input unit 104 is, for example, a universal serial bus (USB) port, an optical drive, or the like, and receives data from the outside. The display 105 is, for example, a liquid crystal display, an organic electroluminescence (EL) display, or the like, and displays information thereon in response to an instruction provided from the controller 106. The controller 106 is, for example, a central processing unit (CPU), a micro-processing unit (MPU), or the like, and operates in accordance with a program stored in the memory 107. The controller 106 processes a request (described below) obtained from any one of the external apparatuses 103, and after completing the processing, the controller 106 instructs the communication unit 108 to notify the corresponding external apparatus 103 that the processing has been completed.

The memory 107 is constituted by, for example, an information recording medium such as a read only memory (ROM), a random access memory (RAM), or a hard disk, and stores a program executed by the controller 106. The memory 107 also operates as a working memory of the controller 106. The communication unit 108 connects the information processing apparatus 101 and an information terminal to each other via the network 102. The details of the communication unit 108 will be described below. The operation unit 109 is constituted by, for example, plural buttons and a touch panel or the like, and outputs an instruction to the controller 106 in accordance with a user operation of providing the instruction. The internal bus 110 connects the input unit 104, the communication unit 108, the controller 106, the memory 107, the display 105, and the operation unit 109 to one another.

The network 102 is, for example, a broadband communication network that connects local area networks (LANs) to one another. For example, as illustrated in FIG. 1, the information processing apparatus 101 and the external apparatuses 103 are connected to each other via LANs. Here, the network 102 may be an internal network installed among apparatuses in a certain limited region, or may be the Internet.

Each of the external apparatuses 103 is a personal computer (PC), a smartphone, or the like constituted by a CPU, a memory, and so forth, and transmits a request to the information processing apparatus 101, such as Line Printer daemon protocol (LPR) or Address Resolution Protocol (ARP).

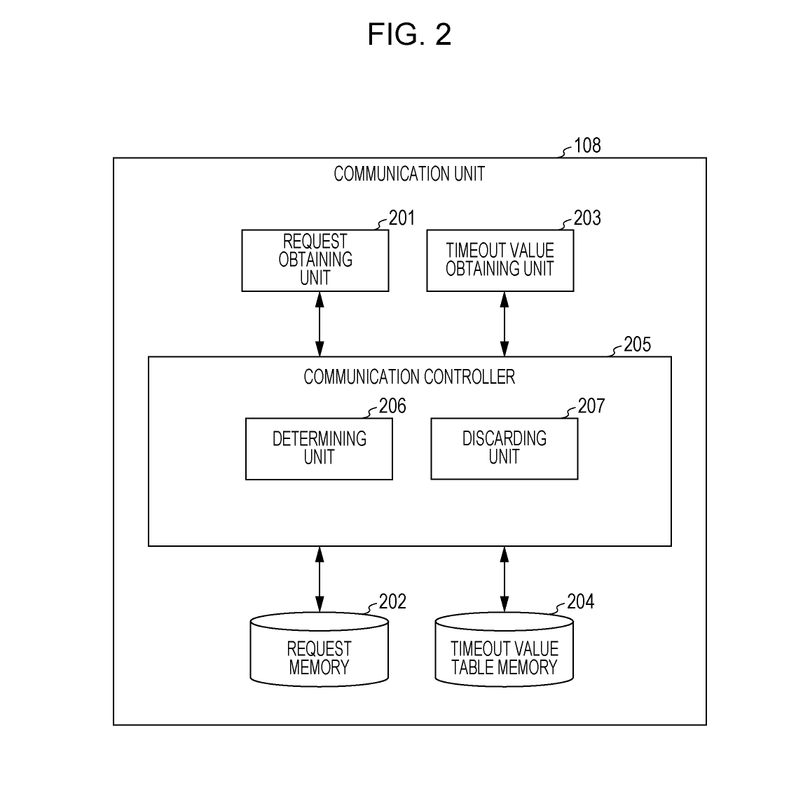

FIG. 2 is a diagram for describing the functional configuration of the communication unit 108 according to the exemplary embodiment. As illustrated in FIG. 2, the communication unit 108 includes a request obtaining unit 201, a request memory 202, a timeout value obtaining unit 203, a timeout value table memory 204, and a communication controller 205.

The request obtaining unit 201 sequentially obtains requests from the individual external apparatuses 103. For example, the request obtaining unit 201 sequentially obtains, from the plural external apparatuses 103 connected to the information processing apparatus 101 via the network 102, pieces of information for identifying the external apparatuses 103 and pieces of information related to the types of requests to the information processing apparatus 101 made by the external apparatuses 103. Specifically, the request obtaining unit 201 sequentially obtains an “ARP” request from the external apparatus 103 having identification information “A”, and an “LPR” request from the external apparatus 103 having identification information “B”. The types of requests obtained by the request obtaining unit 201 are not limited to “ARP” and “LPR”. For example, the types of requests may include a request for notification of information held by the information processing apparatus 101.

The request memory 202 stores the requests obtained by the request obtaining unit 201. In a case where the request obtaining unit 201 has obtained the above-described requests, for example, the request memory 202 sequentially stores the identification information “A” on the external apparatus 103 and the type of request “ARP”, and the identification information “B” on the external apparatus 103 and the type of request “LPR”.

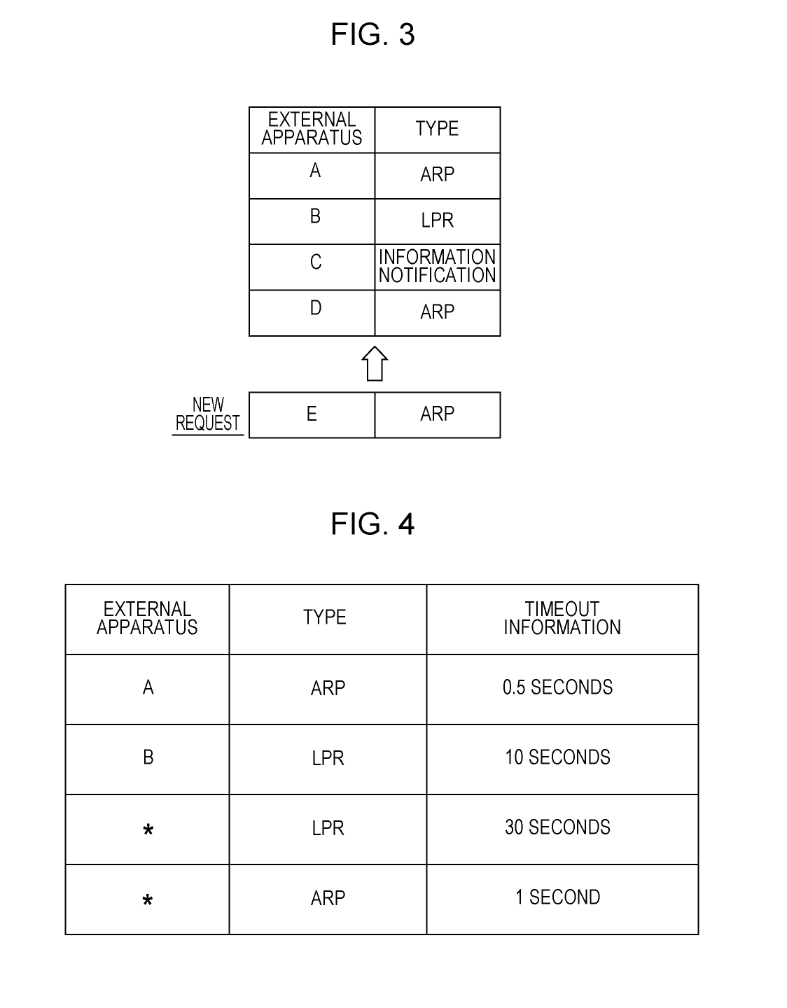

The request memory 202 has an upper limit for the amount of information to be stored. For example, as illustrated in FIG. 3, the request memory 202 has a capacity for storing four requests. Here, FIG. 3 is a diagram for describing an example of information stored in the request memory 202. As illustrated in FIG. 3, the request memory 202 stores a request having the identification information “A” on the external apparatus 103 and the type “ARP”, a request having the identification information “B” on the external apparatus 103 and the type “LPR”, a request having the identification information “C” on the external apparatus 103 and the type “information notification”, and a request having the identification information “D” on the external apparatus 103 and the type “ARP”.

The timeout value obtaining unit 203 obtains timeout values, each of which indicates a time until transmission of a request from one of the external apparatuses 103 is stopped. In a case where the external apparatus 103 transmits a request to the information processing apparatus 101 and the information processing apparatus 101 does not respond to the request, the external apparatus 103 retransmits the request to the information processing apparatus 101 once or plural times. The time until transmission of a request from the external apparatus 103 is stopped is a time until the external apparatus 103 stops the retransmission.

For example, the timeout value obtaining unit 203 obtains timeout values by making an inquiry of the external apparatuses 103 connected to the information processing apparatus 101 when the information processing apparatus 101 is activated and/or at a preset time interval. Specifically, at the timing when the power of the information processing apparatus 101 is turned on and at a preset time interval after the activation, the timeout value obtaining unit 203 performs broadcasting to the external apparatuses 103 connected to the information processing apparatus 101 via the network 102, and thereby requests the external apparatuses 103 to report timeout values. Accordingly, the external apparatuses 103 that have obtained the request notify the timeout value obtaining unit 203 of individual timeout values for individual types of requests, and thereby the timeout value obtaining unit 203 obtains the timeout values.

Specifically, for example, the timeout value obtaining unit 203 obtains, from the external apparatus 103 identified by the identification information “A”, a timeout value “0.5 seconds” in association with the type of request “ARP”. Also, for example, the timeout value obtaining unit 203 obtains, from the external apparatus 103 identified by the identification information “B”, a timeout value “10 seconds” in association with the type of request “LPR”. The method for obtaining timeout values is not limited to the method in which the timeout value obtaining unit 203 makes an inquiry of the external apparatuses 103 connected to the information processing apparatus 101. For example, an application that has been installed into each external apparatus 103 may notify the information processing apparatus 101 at a preset time interval, and thereby timeout values may be obtained.

The timeout value obtaining unit 203 may obtain timeout values in accordance with the types of requests, and/or by using a timeout value table preset in accordance with the external apparatuses 103 that have transmitted requests. Specifically, for example, a description will be given of a case where the timeout value table memory 204 (described below) stores in advance the timeout value table illustrated in FIG. 4. FIG. 4 is a diagram illustrating an example of a timeout value table showing a list of timeout values associated with pieces identification information on the external apparatuses 103 that have transmitted requests and the types of requests.

As illustrated in the second row of the table in FIG. 4, the timeout value table memory 204 stores in advance a timeout value “0.5 seconds” in association with the identification information “A” on the external apparatus 103 and the type of request “ARP”. In a case where the request obtaining unit 201 obtains a request of the type “ARP” from the external apparatus 103 identified by the identification information “A”, the timeout value obtaining unit 203 may obtain the timeout value “0.5 seconds”.

As illustrated in the fourth row of the table in FIG. 4, the timeout value table memory 204 stores in advance a timeout value “30 seconds” in association with the identification information “*” on the external apparatus 103 and the type of request “LPR”. In a case where the request obtaining unit 201 obtains a request of the type “LPR” from the external apparatus 103 identified by the identification information “C”, the timeout value obtaining unit 203 may obtain the timeout value “30 seconds”.

The identification information “*” on the external apparatus 103 is identification information on an arbitrary one of the external apparatuses 103. For example, in the above-described example, in a case where the request obtaining unit 201 obtains a request of the type “LPR”, the timeout value obtaining unit 203 may obtain the timeout value “30 seconds” regardless of the identification information on the external apparatus 103 that has transmitted the request.

In a case where the timeout value table includes the identification information “*” on the external apparatus 103 and the identification information on a specific one of the external apparatuses 103 in association with the same type of request, the timeout value obtaining unit 203 may obtain the timeout value associated with the identification information on the specific external apparatus 103. Specifically, a description will be given of a case where, as illustrated in the third and fourth rows of the table in FIG. 4, the timeout value “10 seconds” is stored in association with the identification information “B” on the specific external apparatus 103 and the type of request “LPR”, and the timeout value “30 seconds” is stored in association with the identification information “*” on the external apparatus 103 and the type of request “LPR”. In this case, in a case where a request of the type “LPR” is obtained from the external apparatus 103 identified by the identification information “B”, the timeout value obtaining unit 203 may obtain the timeout value “10 seconds” even if the timeout value illustrated in the fourth row of the table in FIG. 4 is stored.

The timeout value table memory 204 stores the above-described list of timeout values. Specifically, for example, the timeout value table memory 204 stores the timeout value table illustrated in FIG. 4. As described above, the timeout value table memory 204 may store timeout values obtained by the timeout value obtaining unit 203 from the external apparatuses 103 as a part of the timeout value table, or may store present timeout values. In the timeout value table illustrated in FIG. 4, the information “*” representing arbitrary identification information is included in only the column of the external apparatus 103, but the information “*” representing an arbitrary type of request may be included in the column of the type of request.

The communication controller 205 is, for example, a CPU, an MPU, or the like, includes a determining unit 206 and a discarding unit 207, and controls the operations of the individual units included in the communication unit 108. The determining unit 206 determines, in a case where the request obtaining unit 201 obtains a request, whether or not the request memory 202 has enough space for additionally storing the request. Specifically, for example, in a case where the request memory 202 has a capacity for storing four requests and four requests have been stored therein as illustrated in FIG. 3, the determining unit 206 determines that the request memory 202 does not have enough space for additionally storing the request.

In a case where the determining unit 206 determines that there is no enough space, the discarding unit 207 discards a request that is selected in accordance with the timeout values obtained by the timeout value obtaining unit 203. Specifically, for example, a description will be given of a case where the request obtaining unit 201 has obtained a request of the type “ARP” from the external apparatus 103 identified by identification information “E” in a state where the request memory 202 has a capacity for storing four requests and the requests illustrated in FIG. 3 are stored therein. It is assumed that the timeout value table memory 204 stores the timeout value table illustrated in FIG. 4.

In this case, the discarding unit 207 refers to, by using the timeout value table, the timeout values corresponding to all the requests stored in the request memory 202 and the newly obtained request. In the above-described example, the discarding unit 207 refers to the timeout value “0.5 seconds” for a request having the identification information “A” on the external apparatus 103 and the type “ARP”. Likewise, the discarding unit 207 refers to the timeout value “10 seconds” for a request having the identification information “B” on the external apparatus 103 and the type “LPR”. Also, the discarding unit 207 refers to the timeout value “1 second” for a request having the identification information “D” on the external apparatus 103 and the type “ARP”. Further, the discarding unit 207 refers to the timeout value “1 second” for a request having the identification information “E” on the external apparatus 103 and the type “ARP”. Here, the timeout value table does not include information related to the timeout value corresponding to a request having the identification information “C” on the external apparatus 103 and the type “information notification”, and thus the discarding unit 207 sets a timeout value corresponding to the request to “unknown”.

Subsequently, the discarding unit 207 selects, from among all the requests stored in the request memory 202 and the newly obtained request, a request corresponding to the largest timeout value that has been referred to. In the above-described example, the discarding unit 207 selects a request having the identification information “B” on the external apparatus 103 and the type “LPR”. Desirably, the discarding unit 207 does not select a request corresponding to the timeout value “unknown” that has been referred to. In the above-described example, the timeout value corresponding to the request having the identification information “C” on the external apparatus 103 and the type “information notification” is “unknown”, and thus it is desirable for the discarding unit 207 not to select the request.

Subsequently, the discarding unit 207 discards the selected request. In the above-described example, the discarding unit 207 discards, from the request memory 202, the request having the identification information “B” on the external apparatus 103 and the type “LPR”. Also, the discarding unit 207 provides an instruction to store, in the request memory 202, the newly obtained request having the identification information “E” on the external apparatus 103 and the type “ARP”.

The above-described configuration of the information processing apparatus 101 and the communication controller 205 is an example, and the exemplary embodiment is not limited thereto. For example, the information processing apparatus 101 may be configured as an apparatus that has, as operation modes, a normal mode in which a request obtained from one of the external apparatuses 103 is immediately processed and a power saving mode in which a request obtained from one of the external apparatuses 103 is stored in the request memory 202 so as to be processed after the operation mode has shifted to the normal mode.

For example, the controller 106 and the communication controller 205 may be configured so that power is supplied to both of them in the normal mode, and that power is supplied to only the communication controller 205 and power supply to the controller 106 is stopped in the power saving mode. Specifically, for example, the controller 106 may be configured to control the operations of the input unit 104, the display 105, the controller 106, the memory 107, the communication unit 108, and the operation unit 109 in accordance with a program stored in the memory 107 in the normal mode, and to stop the processing in the power saving mode. The communication controller 205 may perform processing in response to an instruction provided from the controller 106 in the normal mode, and may independently control the operations of the request obtaining unit 201, the timeout value obtaining unit 203, the determining unit 206, the discarding unit 207, the request memory 202, and the timeout value table memory 204 in the power saving mode.

In general, in a case where the information processing apparatus 101 is configured to have the power saving mode and the normal mode in order to reduce power consumption of the information processing apparatus 101, it takes time to start processing based on a request stored in the request memory 202 after the controller 106 has been activated. Thus, during a shift from the power saving mode to the normal mode, there is a high probability that the request memory 202 does not have enough space for additionally storing a request, compared to a state in which the information processing apparatus 101 is operating in the normal mode. Thus, the communication controller 205 is configured to independently select a request to be discarded during a shift from the power saving mode to the normal mode, and accordingly a request to be discarded is selected in accordance with timeout values even at the timing when there is a high probability that the capacity of the request memory 202 is insufficient.

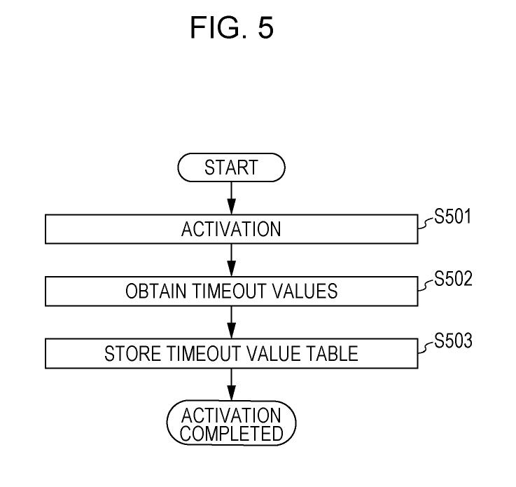

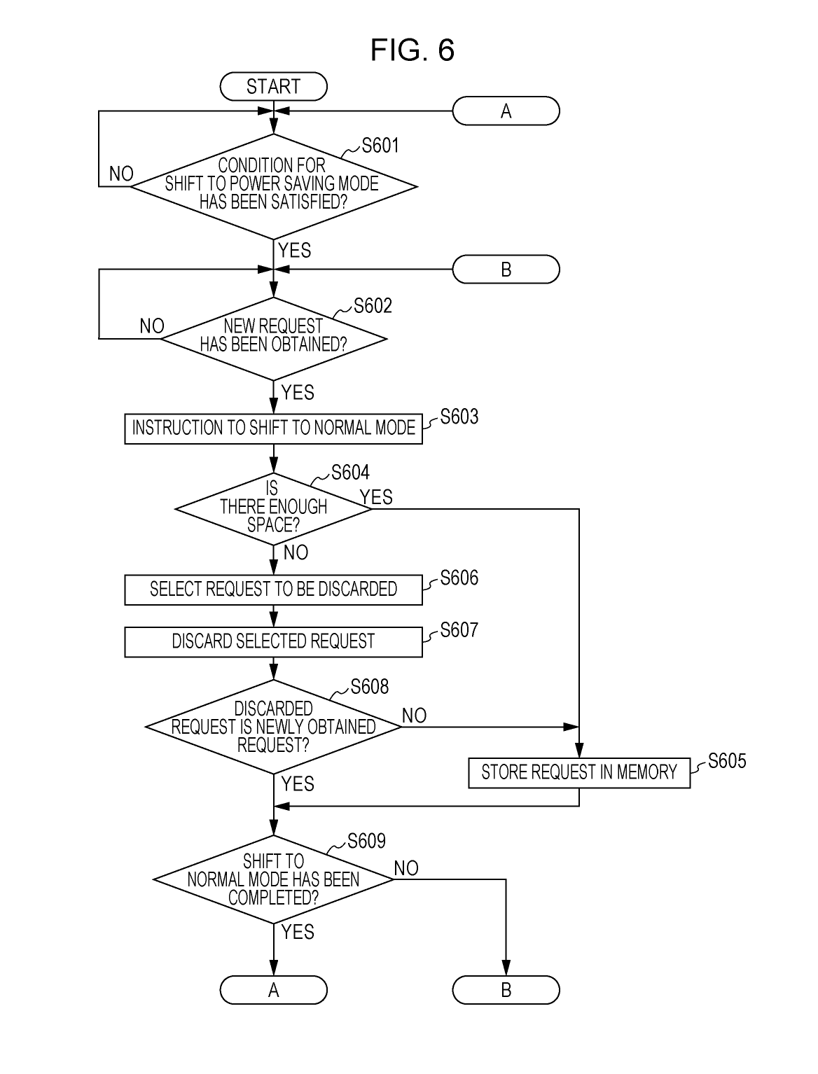

Next, a flow of processing performed by the information processing apparatus 101 will be described with reference to FIGS. 5 and 6. FIG. 5 illustrates a processing flow that is performed when the information processing apparatus 101 is activated in the exemplary embodiment of the present invention. The processing flow described below is an example, and the exemplary embodiment is not limited thereto.

First, the information processing apparatus 101 is activated upon power-on (step S501). The controller 106 and the communication controller 205 are supplied with power and are thereby activated when the information processing apparatus 101 is activated. Subsequently, the timeout value obtaining unit 203 obtains timeout values (step S502). For example, the timeout value obtaining unit 203 makes an inquiry of all the external apparatuses 103 connected to the information processing apparatus 101 via the network 102, and thereby obtains timeout values. Subsequently, the timeout value table memory 204 stores a timeout value table on the basis of the timeout values obtained in step S502 (step S503).

As described above, after being activated, the information processing apparatus 101 stores a timeout value table on the basis of timeout values obtained from the external apparatuses 103 and starts operation in the normal mode.

FIG. 6 illustrates a processing flow that is performed when the information processing apparatus 101 shifts from the normal mode to the power saving mode and then shifts to the normal mode again in the exemplary embodiment of the present invention.

At the start of the processing flow illustrated in FIG. 6, the information processing apparatus 101 is operating in the normal mode. As long as the information processing apparatus 101 does not satisfy a condition for shift to the power saving mode, the information processing apparatus 101 continues operating in the normal mode. If the information processing apparatus 101 satisfies the condition for shift to the power saving mode, the information processing apparatus 101 shifts to the power saving mode, and the processing proceeds to step S602 (step S601). Specifically, for example, in a case where a user operation is not performed on the information processing apparatus 101 for a preset time period, the information processing apparatus 101 shifts to the power saving mode. Also, the information processing apparatus 101 may shift to the power saving mode in response to an explicit instruction to shift to the power saving mode provided from the user to the information processing apparatus 101. While the information processing apparatus 101 is operating in the normal mode, requests obtained by the request obtaining unit 201 are sequentially processed by the controller 106.

Subsequently, if the request obtaining unit 201 obtains a new request after the information processing apparatus 101 has shifted to the power saving mode, the processing proceeds to step S603 (step S602). On the other hand, until the request obtaining unit 201 obtains a new request in a state where the information processing apparatus 101 is operating in the power saving mode, the information processing apparatus 101 continues operating in the power saving mode. The request obtained under the power saving mode is stored in the request memory 202 in accordance with the control performed by the communication controller 205 because the communication controller 205 is operating even in the power saving mode.

Subsequently, if the request obtaining unit 201 obtains a new request in the power saving mode, the communication controller 205 instructs the controller 106 to shift from the power saving mode to the normal mode.

Subsequently, the determining unit 206 determines whether or not the request memory 202 has enough space for additionally storing the request obtained by the request obtaining unit 201 in step S602 (step S604). If the determining unit 206 determines that the request memory 202 has the enough space, the processing proceeds to step S605. If the determining unit 206 determines that the request memory 202 does not have the enough space, the processing proceeds to step S606. If the determining unit 206 determines that the request memory 202 has the enough space, the request memory 202 stores the request obtained by the request obtaining unit 201 in step S602 (step S605).

On the other hand, if the determining unit 206 determines that the request memory 202 does not have the enough space, the discarding unit 207 selects, in accordance with the timeout values obtained by the timeout value obtaining unit 203, a request to be discarded (step S606), and discards the selected request (step S607). If the request discarded in step S607 is not the request newly obtained in step S602, the processing proceeds to step S605 (step S608). If the request discarded in step S607 is the request newly obtained in step S602, the processing proceeds to step S609. If the request discarded in step S607 is not the request newly obtained in step S602, enough space for additionally storing the new request is generated in the request memory 202, and thus the request memory 202 stores the request obtained by the request obtaining unit 201 in step S602.

Subsequently, if the newly obtained request is discarded in step S608 or if the newly obtained request is stored in step S605, the processing proceeds to step S609. It takes time for the information processing apparatus 101 to shift from the power saving mode to the normal mode. Thus, the processing proceeds to A if the shift from the power saving mode to the normal mode has been completed at the time of step S609, and the processing proceeds to B if the shift has not been completed (step S609). That is, if the shift to the normal mode has been completed, the information processing apparatus 101 operates in the normal mode and performs processing on the basis of the requests stored in the request memory 202.

The request discarded in step S607 is retransmitted from the external apparatus 103 as the transmitter until the time indicated by the timeout value has elapsed. The request discarded in step S607 has a larger timeout value than the requests that have not been discarded. Even if it takes time for the information processing apparatus 101 to shift to the normal mode, if the time corresponding to the timeout value is longer than the time that has been spent to shift to the normal mode, the request obtaining unit 201 obtains the request again, and thereby the information processing apparatus 101 performs processing in accordance with the request discarded in step S607 after shifting to the normal mode. Therefore, as a result of preferentially storing a request corresponding to a smaller timeout value over a request corresponding to a larger timeout value, the situation may be prevented from occurring where a request transmitted during a shift to the normal mode of the information processing apparatus 101 is discarded without being processed.

On the other hand, if the timing at which step S609 is performed is during a shift from the power saving mode to the normal mode, steps S602 to S608 are continuously performed until the shift is completed, and thereby the request memory 202 preferentially stores therein a request corresponding to a smaller timeout value that is referred to. After the mode has shifted from the power saving mode to the normal mode, the controller 106 performs processing on the basis of the requests stored in the request memory 202.

As described above, a request for which the time until transmission of the request from the external apparatus 103 is stopped is the longest is discarded, so as to reduce the capacity of the request memory 202 that is necessary to store requests. Also, a request that has been discarded is obtained again so as to prevent the situation from occurring where processing corresponding to the request is not performed.

The present invention is not limited to the above-described exemplary embodiment, and various modifications may be implemented. For example, the configuration according to the exemplary embodiment may be replaced by a configuration that is substantially the same as the configuration described above in the exemplary embodiment or a configuration having the same operation and effect. Specifically, for example, the configuration of the information processing apparatus 101 and the processing flow performed thereby is an example, and the exemplary embodiment is not limited thereto.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a request obtaining unit that sequentially obtains requests from a plurality of external apparatuses;
a request memory that stores the requests;
a timeout value obtaining unit that obtains timeout values, each of the timeout values indicating a time until transmission of a request from one of the plurality of external apparatuses is stopped;
a determining unit that determines, in a case where a request is obtained, whether or not the request memory has enough space for additionally storing the request; and
a discarding unit that discards, in a case where the determining unit determines that the request memory does not have the enough space, a request that is selected in accordance with the timeout values obtained by the timeout value obtaining unit.

2. The information processing apparatus according to claim 1, wherein
the information processing apparatus is an apparatus that has, as operation modes, a normal mode in which a request obtained from one of the plurality of external apparatuses is immediately processed and a power saving mode in which a request obtained from one of the plurality of external apparatuses is stored in the request memory so as to be processed after the operation mode has shifted to the normal mode, and
the discarding unit discards the selected request during a shift from the power saving mode to the normal mode.

3. The information processing apparatus according to claim 1, wherein the timeout value obtaining unit obtains the timeout values by making an inquiry of the plurality of external apparatuses connected to the information processing apparatus when the information processing apparatus is activated and/or at a preset time interval.

4. The information processing apparatus according to claim 2, wherein the timeout value obtaining unit obtains the timeout values by making an inquiry of the plurality of external apparatuses connected to the information processing apparatus when the information processing apparatus is activated and/or at a preset time interval.

5. The information processing apparatus according to claim 1, wherein the timeout value obtaining unit obtains the timeout values in accordance with types of the requests and/or by using a timeout value table that is preset in accordance with the plurality of external apparatuses that have transmitted the requests.

6. The information processing apparatus according to claim 2, wherein the timeout value obtaining unit obtains the timeout values in accordance with types of the requests and/or by using a timeout value table that is preset in accordance with the plurality of external apparatuses that have transmitted the requests.

7. The information processing apparatus according to claim 3, wherein the timeout value obtaining unit obtains the timeout values in accordance with types of the requests and/or by using a timeout value table that is preset in accordance with the plurality of external apparatuses that have transmitted the requests.

8. The information processing apparatus according to claim 4, wherein the timeout value obtaining unit obtains the timeout values in accordance with types of the requests and/or by using a timeout value table that is preset in accordance with the plurality of external apparatuses that have transmitted the requests.

9. An information processing method comprising:
sequentially obtaining requests from a plurality of external apparatuses;
storing the requests in a request memory;
obtaining timeout values, each of the timeout values indicating a time until transmission of a request from one of the plurality of external apparatuses is stopped;
determining, in a case where a request is obtained, whether or not the request memory has enough space for additionally storing the request; and
discarding, in a case where it is determined that the request memory does not have the enough space, a request that is selected in accordance with the obtained timeout values.

10. A non-transitory computer readable medium storing a program causing a computer to execute a process for information processing, the process comprising:
sequentially obtaining requests from a plurality of external apparatuses;
storing the requests in a request memory;
obtaining timeout values, each of the timeout values indicating a time until transmission of a request from one of the plurality of external apparatuses is stopped;
determining, in a case where a request is obtained, whether or not the request memory has enough space for additionally storing the request; and
discarding, in a case where it is determined that the request memory does not have the enough space, a request that is selected in accordance with the obtained timeout values.
